(19) United States
(12) Patent Application Publication
(10) Pub. No.: US 2013/0036669 A1
(43) Pub. Date: Feb. 14, 2013

(54) APPARATUS FOR GROWING PLANTS HYDROPONICALLY

(71) Applicants: MEHDI RABII, WILDOMAR, CA (US); SKYE RABII, WILDOMAR, CA (US)

(72) Inventors: MEHDI RABII, WILDOMAR, CA (US); SKYE RABII, WILDOMAR, CA (US)

(21) Appl. No.: 13/556,978

(22) Filed: Jul. 24, 2012

Related U.S. Application Data
(60) Provisional application No. 61/521,452, filed on Aug. 9, 2011.

(51) Int. Cl. A01G 31/02

(52) U.S. Cl. 47/62 R

(57) ABSTRACT

An apparatus for growing plants hydroponically. The apparatus comprises a base or pot portion for receiving a growing media and plant. Formed beneath the base portion is a slotted downspout that is operative to allow water and nutrients into the base and allow the plant roots to grow in their natural orientation. A lid may also be provided, preferably having an aperture formed thereon, for forming a closure about the pot or base portion. In use, growing media and plant are placed in the base. The lid element is then placed upon the top portion of the base or pot and thereafter positioned into any reservoir of suitable size through which water and air will travel to feed the plant via the slotted downspout.

### CROSS-REFERENCE TO RELATED APPLICATIONS

The present application claims priority to U.S. Provisional Patent Application Ser. No. 61/521,452, filed Aug. 9, 2011, entitled APPARATUS FOR GROWING PLANTS HYDROPONICALLY, the teachings of which are incorporated herein by reference.

### STATEMENT RE: FEDERALLY SPONSORED RESEARCH/DEVELOPMENT

Not Applicable

### BACKGROUND

The practice of growing plants hydroponically, namely, the growing of plants in nutrient solutions with or without an inert medium to provide mechanical support, is well-known in the art. There are currently two problems when growing plants hydroponically. The first problem when growing plants with different substrates (such as dirt, rock wool, expanded clay, coconut fiber, and perlite) in different hydroponic methods (such as passive wick, ebb and flow, top feed, aeroponics, deep water culture and Nutrient Film Technique NFT) one would need multiple types of hardware systems and/or multiple types of pots to grow them in. Currently there is no single hardware device that accepts all available substrates and works within all available hydroponic methods in one. The second problem is that there is no hardware device that bridges all of the methods of hydroponics and allows you to move a plant from one hydroponic system to another and back without damage and stress to the plant and root zone.

There is thus a substantial need in the art that addresses the aforementioned deficiencies. There is a further need in the art for such a system is of simple construction, low cost to manufacture, exceptionally durable and far easier to utilize than prior art systems for facilitating the hydroponic growth of plants.

### BRIEF SUMMARY

The present invention specifically addresses and alleviates the above-identified deficiencies in the art. The invention, which may be called an “Aerobrick,” is an apparatus comprised of a plastic square pot or base for receiving a plant and growth media with attached slotted downspout and lid for growing plants in any substrate and in any hydroponic system.

The unique design of an Aerobrick is made to enclose the substrate entirely without gaps and spaces between the substrate and the pot that would result in directly exposing the roots to air. This direct exposure is well known to cause plant stress and death. The Aerobrick is designed and shaped to seal in substrates such as rock wool, dirt, fiber, and expanded clay. Sealing the substrate within the Aerobrick and its sealed lid virtually eliminates moisture evaporation and controls humidity. The Aerobrick's downspout allows the roots to follow a natural growth pattern and reach water in the reservoir. The unique design of the Aerobrick's downspout also allows for the plant to be moved back and forth between different hydroponic systems without causing damage or stress to the plant because the stabilized root zone surrounding the plant is encased in the Aerobrick above. This unique shape both allows the roots to naturally keep growing while protecting the root ball.

The Aerobrick apparatus, as discussed above, is preferably formed from plastic, and may be made using conventional manufacturing techniques, such as injection molding and the like. It should be understood, however, that the apparatus of the present invention may be made from any of a variety of materials well-known to those skilled in the art, including glass, wood, metal, ceramic materials and various combinations thereof as may be desired. Additionally, the apparatus may be configured such that the pot portion and slotted downspout are formed as unitary structure or, alternatively, may be formed as separate components and fastened to one another, either permanently or detachably as may be desired. A lid element may be provided with an aperture thereon to give the plant disposed within the base access to air and further allows the plant to be accessed, as may be desired. In this regard, the lid element typically must be interconnected to the base to enclose the root zone and growing media, as discussed herein.

To grow plants using an Aerobrick you will need a plant, growing media, and a water or nutrient reservoir. Generally speaking, the Aerobrick base provides a container for the growth media and the lid encloses this media. The slotted downspout gives the growing media access to air and water and allows a plant's roots to follow their natural growth pattern. To achieve that end, the selected growing media is placed in the Aerobrick base. Thereafter, place the selected plant into the growing media and place the Aerobrick lid onto the Aerobrick base. The Aerobrick can now be placed into any reservoir such as a 2″-4″ opening. Irregular size holes do not matter as the Aerobrick base covers up to a 4 inch hole. Water and air will travel through the slotted downspout and feed the plant. Along those lines, the Aerobrick base provides a container for the growing media and the lid encloses such media.

Alternatively, it should be understood that the Aerobrick can be used with no growing media at all. In such applications, the lid element and base opening can allow for the Aerobrick to be used in an aeroponic or nutrient mist application, as may be desired. Other applications will readily be appreciated by those skilled in the arts.

### BRIEF DESCRIPTION OF THE DRAWINGS

These as well as other features of the present invention will become more apparent upon reference to the drawings.

FIG. 1 is a perspective illustration of an apparatus for growing plants hydroponically as constructed in accordance with a preferred embodiment of the present invention showing the combination of a pot or base element with an attached slotted downspout.

FIG. 2 is a perspective illustration of a lid element for use with the base and slotted downspout depicted in FIG. 1.

FIG. 3 is a perspective view of the lid of FIG. 2 as interconnected with the base and downspout of FIG. 1.

FIG. 4 is a bottom view of the apparatus of FIG. 1 depicting the downspout and base.

FIG. 5 is a side view of the lid, base and downspout of FIG. 4.

FIG. 6 is a perspective view of the lid, base and downspout of FIG. 5.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

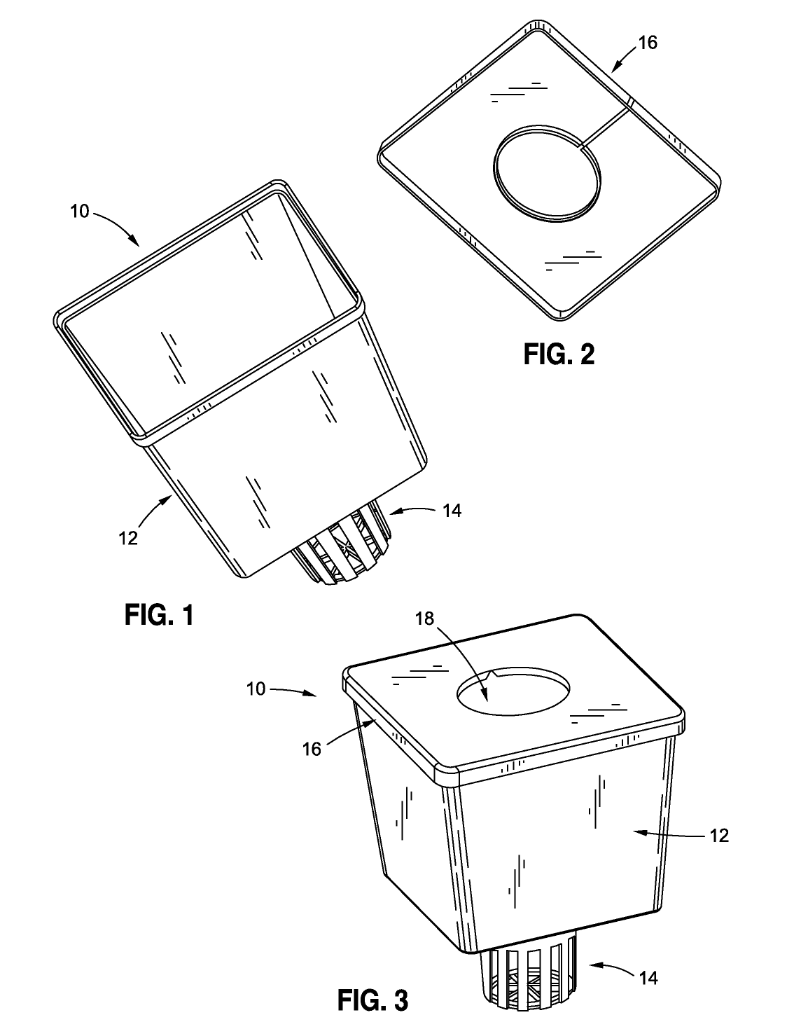

Referring now the figures, and initially to FIG. 1, there is shown an apparatus 10 for growing plants hydroponically that is constructed in accordance with a preferred embodiment of the present invention. As illustrated, the apparatus 10 comprises a pot or base portion 12 that is operative to define an upper peripheral edge opening and an interior into which a plant may be planted. Although depicted as a generally cube-like structure, it should be readily understood and recognized by those skilled in the art that the pot or base portion 12 may take any of a variety of geometrical configurations and in no way should be construed to assume any particular geometric configuration.

Emanating downwardly from the base 12 is slotted downspout 14. As will be appreciated by those skilled in the art, the slotted downspout will be operative to fluidly interact with a reservoir, the latter being operative to provide water, air and nutrients per conventional hydroponic growing practices.

The base 12 and slotted downspout 14 elements may be formed from any of a variety of materials well-known to those skilled in the art, including plastic, glass, metal, wood, ceramic materials and combinations thereof. The elements may be fabricated by any of a variety of well-known manufacturing practices well-known to those skilled in the art. Ideally, such elements are formed as molded plastic materials via conventional injection molding techniques. Along those lines, the base and slotted downspout may be formed as separate elements that are mechanically coupled to one another such as by a snap-fastening interconnection. Alternatively, the components 12, 14 may be integrally molded to one another as may be desired. Along those lines, the base 12 and slotted downspout 14 elements may be operative to be detachably fastened to one another to thus enable the same to be assembled and disassembled easily as may be desired.

Referring now to FIG. 2, there is shown a lid element 16 that is operative to form a closure about the peripheral opening defined by base 12. Lid 16, as per base 12 and slotted downspout 14, may be fabricated from any of a wide variety of materials known to those in the art, including plastic formed by injection molding. Ideally, the lid 16 will be operative to form closure about the opening of base 12, as depicted in FIG. 3. The lid 16 will further preferably include an aperture 18 to thus enable the plant ultimately disposed within the base 12 to be visibly observed, as well as to further allow air to access the interior of the base 12 to facilitate plant growth.

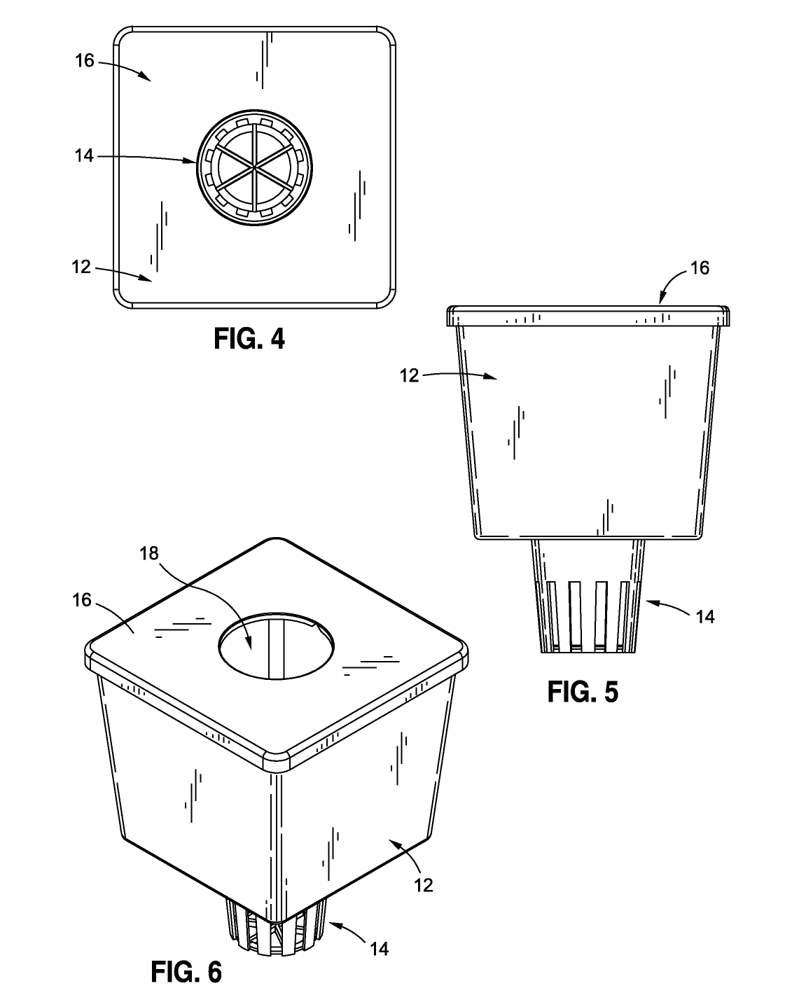

Referring now to FIGS. 4-6, there is shown the dimensions of the apparatus 10 of the present invention as constructed according to a preferred embodiment. In this regard, it is contemplated that the lid element 16 may be formed to have a generally flat, square-like configuration wherein each side is approximately 5 inches (4.98″ as shown). With respect to the depth of the interior of the base 12 with lid 16 thereon, in the embodiment shown, such depth will be approximately 4.12 inches. The entire height from top of lid 16 to the bottom of slotted downspout 14 would be approximately 6.12 inches. As should be readily appreciated by those skilled in the art, however, the dimensions provided herein are merely illustrative of a preferred embodiment only and it would be well-known and well within the skill level of an ordinary artisan to modify such dimensions as may be desired for a particular application or to fit within a certain spatial dimension.

With respect to the use of apparatus 10 to grow plants hydroponically, it will necessarily require a plant, growing media, and a water or nutrient reservoir. Initially, the growth media is placed within the base 12 and thereafter the selected plant is placed into the growing media. The lid 16 may then be closed upon the top of base 12 and the assembled unit placed into any reservoir having an opening of sufficient size and depth. In the embodiment shown in FIGS. 4-6, it is contemplated that the apparatus 10 can be placed into any reservoir with a 2 inch to 4 inch opening. Moreover, and as discussed above, irregular size holes would not be problematic insofar as the base 12 is operative to cover up to a 4 inch hole.

As will be readily understood by those skilled in the art, water and air will travel through the slotted downspout 14 and feed the plant as desired. Alternatively, in certain applications it will be understood that growing media may be required and that the apparatus 10 of the present invention can be utilized to grow plants in aeroponic applications whereby the opening 20 of lid 16 and slotted downspout 14 will provide means for the plant to access the necessary moisture and nutrients.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention. For example, the lid 16 may take any of a variety of configurations, and in some applications may be entirely optional; however, it should be understood that the lid element 16 typically must be on base 12 to enclose the root zone and growing media as is required for most hydroponic applications.

What is claimed is:

1. An apparatus for growing plants hydroponically comprising:
a base portion defining an upper peripheral opening and an interior for receiving a plant growth media and a plant; and a slotted downspout depending from said base, said slotted downspout being in fluid communication with said base and defining access means by which water, air and nutrients can be administered to said plant and growth media disposed within said base.

2. The apparatus of claim 1 further comprising a lid element positionable upon said base and operative to define an enclosure about said plant and growth media disposed within said base.

3. The apparatus of claim 2 wherein said base is formed in a generally cube-like structure and said lid is formed to have a generally square-shape and size and dimension to form a covering about the upper peripheral opening defined by said base.

4. The apparatus of claim 3 wherein said lid element has at least one aperture formed thereon.

5. The apparatus of claim 2 wherein said base, slotted downspout and lid are formed from molded plastic.
